(19) United States
(12) Patent Application Publication
(10) Pub. No.: US 2024/0289685 A1
(43) Pub. Date: Aug. 29, 2024

(54) Determining Machine Learning Model Performance on Unlabeled Out Of Distribution Data

(71) Applicant: Oracle International Corporation, Redwood City, CA (US)

(72) Inventors: Michael Louis Wick, Lexington, MA (US); Ariel Kobren, Cambridge, MA (US); Swetasudha Panda, Burlington, MA (US); John Sullivan, Medford, MA (US)

(21) Appl. No.: 18/176,380

(22) Filed: Feb. 28, 2023

(51) Int. Cl. G06N 20/00

(52) U.S. Cl. CPC G06N 20/00

(57) ABSTRACT

Machine learning model performance may be determined on unlabeled out of distribution data. A source data set may be obtained for training a machine learning model. Unbiased estimates may be determined for baseline performance indicators of the machine learning model applied to a target dataset without ground truth labels using importance sampling weights. Performance metrics may then be determined using the baselined performance indicators and provided.

### BACKGROUND

### Field of the Disclosure

This disclosure relates to determining performance of trained machine learning models.

### Description of the Related Art

Machine learning systems are increasingly employed to improve decision making in applications. For example, various different systems may utilize a trained machine learning model to make a control decision in a larger workflow for accomplishing various tasks. Because the inferences made by machine learning models impacts the performance of downstream tasks, the performance of machine learning models is studied to understand whether a machine learning model should be deployed or updated in an application.

### SUMMARY

Techniques for determining machine learning model performance on unlabeled out of distribution data are described. Various systems, services, applications, methods, and program executable instructions may implement different embodiments of theses techniques. A source dataset may be obtained with corresponding ground truth labels for items in the source dataset. Respective unbiased estimates may be determined for false positives, false negatives, true positives, and true negatives for performance of a machine learning model applied to a target dataset without corresponding ground truth labels according to importance sampling weights applied to the predictions of the machine learning model made given the items in the source dataset with respect to corresponding ground truth labels for the items in the source dataset. Based on two or more of the respective unbiased estimates, a performance metric may be determined for the machine learning model on the target dataset without corresponding ground truth labels. The performance metric for the machine learning model on the target dataset may be provided.

### BRIEF DESCRIPTION OF THE DRAWINGS

FIG. 1 is a logical block diagram of an exemplary machine learning evaluation system that implements target data performance analysis for a machine learning model system, according to some embodiments.

FIG. 2 is a logical block diagram illustrating target data performance analysis for a machine learning model, according to some embodiments.

FIG. 3 is a flow diagram illustrating methods and techniques for determining machine learning model performance on un-labeled performance distribution data, according to some embodiments.

FIG. 4 is a flow diagram illustrating methods and techniques for training density estimators for determining machine learning model performance, according to some embodiments.

FIG. 5 illustrates an example computing system, according to some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (e.g., meaning having the potential to) rather than the mandatory sense (e.g. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Various techniques for determining machine learning model performance on unlabeled out of distribution data are described herein. Machine learning models may be artifacts (e.g., formulas, functions, data structures, such as artificial neural networks, support vector machines, etc., or various other model information) that can make a prediction (sometimes referred to as an inference) given input data. The types of predictions and input data may vary according to the type of task that the machine learning model is implemented to perform. For instance, different types of tasks include value predictions, classification or label prediction, computer vision, speech recognition, natural language processing, among various other tasks. Different techniques for training or otherwise generating machine learning models may be performed, including, but not limited to, supervised training (which may utilize training data with the ground truth (e.g., correct) answer for corresponding input data), semi-supervised training, or unsupervised machine learning (e.g., which may utilize training data that without ground truth answers for corresponding input data).

To understand when and if a machine learning model is ready for deployment in an application or for other uses, the performance of the machine learning model may be evaluated. Typically, machine learning models may be evaluated on labeled test data that may have been held-out from a larger set of training data to estimate how well the machine learning model performs. However, such an evaluation might not be a good estimate of actual real-world performance, especially if the model is to be deployed on data that comes from a different distribution than the labeled test data's distribution. Various embodiments discussed below provide techniques for estimating a machine learning model's performance on such out of distribution deployment data for which there are no labels. In this way, scientists, engineers, or other developers building, training, or otherswise developing machine learning models can use their existing labeled data to better estimate how well machine learning models perform on unlabeled data (e.g., real-world data, such as customer or application data).

The following discussion provides an exemplary way of describing scenarios in which determining machine learning model performance on unlabeled out of distribution data may be implemented. Formally, there may be two data distributions x˜Dₛ, x˜Dₜ that share a common labeling function l: X→Y that maps data points to ground truth labels. There may also be two datasets that are respectively drawn from these distributions. A source dataset Dₛ={ [symbol] x, [symbol] (x) [symbol] |x˜Dₛ} for which there are labels and a target dataset Dₜ={x|x˜Dₜ} for which there are not have labels. A model f: X→Y may take an input x∈X and make a prediction y∈Y. An evaluation metric μ(f, l, Dₜ)→s may take a model and a labeled dataset and output a score r (e.g., r∈[0,1]) indicating how well the model performs compared to the labeling function l. Ideally, if the two data distributions are the same then evaluating model performance on the source data is indicative of performance on the target data. But in many real-world scenarios Dₜ≠Dₛ. Therefore, techniques for determining machine learning model performance on unlabeled out of distribution data may be implemented to faithfully estimate the model's f(x) performance under metric μ on some target data Dₜ given that there may only have access to the labels for some source data Dₛ.

In various embodiments, an evaluation may take advantage of statistical estimation in which the values of four underlying statistics of model performance may be first estimated. These four underlying or baseline performance indicators may be false positives (e.g., a prediction that something is true when it is not true), false negatives (e.g., a prediction that something is not true when it is true), true positives (e.g., a prediction that something is true when it is true), and true negatives (e.g., a prediction that something is not true when it is not true). These baseline performance indicators may be predicted as expected values of random variables computed over data distributions. From these four estimated baseline performance indicators, many of the most common evaluation metrics in machine learning, including precision, recall, f1 and accuracy can then be determined.

Next, given this formulation, an estimate of the four underlying statistics can be determined for the unlabeled target data Dₜ but only using labels from the source dataset Dₛ, by treating evaluation as importance sampling. While other techniques may utilize importance sampling for training with out of distribution data, various embodiments may utilize importance sampling for evaluation of machine learning model performance. The labeled test data, for which there are labels, may be treated as the proposal distribution and treat the unlabeled deployment data, for which there are no labels, as the target distribution. Then, assuming that the labeling function is the same for both the test and deployment data, density estimates can be used, which do not require labels, of the test data and deployment data as importance weights that weigh each test data point's contribution to the statistics. For instance, language modeling techniques can be used to get these density estimates.

In various embodiments, test data points that have higher probability under the deployment density may have a higher weight and therefore may contribute more to the underlying evaluation statistics than points that have lower probability under the deployment density. When the density estimates perfectly model the underlying data distributions and assuming the labeling function does not change, it can be shown that that this provides an unbiased estimate of the underlying evaluation statistics, and results in a consistent estimate for the downstream evaluation metrics like precision, recall and f1.

Compared to conventional machine learning evaluation which assumes labeled in-distribution data to estimate performance, various embodiments of techniques for determining machine learning model performance on unlabeled out of distribution data allow practitioners to estimate a machine learning model's performance on unlabeled out-of-distribution data. This is a largely overlooked problem in machine learning. While importance sampling is used in machine learning for a variety of situations that involve out of distribution data, the primary use has been in training machine learning models, including classifiers, contextual bandits, and off-policy reinforcement learning algorithms. For instance, existing methods that make use of importance sampling are unable to cope with non-linear functions of data, like F1, which makes them less useful for evaluation specifically where such functions are commonly used. Typically, they can only be used to estimate for training rather than evaluation. As described herein, in various embodiments techniques for determining machine learning model performance on unlabeled out of distribution data can handle nearly any evaluation metric—linear or not—including precision, recall, f1, accuracy, as well as many fairness metrics like disparate impact.

Various embodiments of determining machine learning model performance on unlabeled out of distribution data also improve over existing machine learning model evaluation systems, applications, and techniques by allowing practitioners to better estimate model accuracy on unlabeled out of distribution data. This is an advantage over the conventional machine learning evaluation which just measures performance on the labeled in-distribution test data, making the tacit assumption that the unlabeled deployment data comes from the same or similar distribution. As discussed in detail below, in various embodiments, the below techniques for determining machine learning model performance on unlabeled out of distribution data support evaluation of and the ability to handle non-linear functions of the data like f1.

First consider the typical workaday case for which a target dataset does have labels. Suppose there is a target dataset Dₜ on which it is desirable to evaluate a machine learning model f(x)→y in terms of a performance metric μ like precision, recall or F1. When there is access to the ground truth labels, the underlying statistics may be determined by counting the number of true positives, false positives, false negatives, true negatives and then combine them into precision, recall, F1, accuracy or other performance metrics of interest. Each of these statistics count the number of examples in the corpus for which some indicator function is true. For example, if an evaluation μ is precision, then count the number of true positives tp and false positives fp and use this to compute y under the definition of precision:

$$tp = {\sum }_{x ∈ {D}_{t}} [ f ( x ) = ℓ ( x ) ∧ ℓ ( x ) = 1 ]$$

$$fp = {\sum }_{x ∈ {D}_{t}} [ f ( x ) \neq ℓ ( x ) ∧ f ( x ) = 1 ]$$

$$μ = \frac{tp}{tp + fp}$$

Equivalently, it may be more efficient to work with the average values of the underlying indicator functions rather than their raw counts. Let t̅p̅ₙ, f̅p̅ₙ, f̅n̅ₙ, t̅n̅ₙ be the average values over n examples of the underlying indicators for true positives, false positives, false negatives and true negatives respectively. To check for many metrics of interest, the average can be worked with directly instead of the count. Continuing with the example, above, the 1/n term may be seen to cancel from the computation of precision and thus μ̅ₙ=μ in the equation below:

$${\overline{tp}}_{n} = \frac{1}{n} {\sum }_{x ∈ {D}_{t}} [ f ( x ) = ℓ ( x ) ∧ ℓ ( x ) = 1 ]$$

$${\overline{fp}}_{n} = \frac{1}{n} {\sum }_{x ∈ {D}_{t}} [ f ( x ) \neq ℓ ( x ) ∧ f ( x ) = 1 ]$$

$${\overline{μ}}_{n} = \frac{{\overline{tp}}_{n}}{{\overline{tp}}_{n} + {\overline{fp}}_{n}}$$

This allows for the interpretation of these statistics as Monte Carlo estimators for the expected values of the corresponding indicator functions under the target distribution Dₜ from which the x∈Dₜ are independent and identically distributed rand variables (iid) draws. Consequently, the estimators may be unbiased and also converge to the true expected value in the limit of infinite data. The unbiased property may be shown via the linearity of expectations.

For instance, the raw evaluation statistics t̅p̅ₙ, f̅p̅ₙ, f̅n̅ₙ, t̅n̅ₙ can be viewed as Monte Carlo estimates, and are unbiased estimators of their underlying indicator functions under the true target distribution Dₜ. It may be shown for true positives but the others are similar. In this case E_{x˜D}_{ₜ}_{[t̅p̅}_{ₙ}_{]}=tp*

$${E}_{x ∼ {D}_{t}} [ {\overline{tp}}_{n} ] = {E}_{x ∼ {D}_{t}} [ \frac{1}{n} {\sum }_{x ∈ {D}_{t}} [ f ( x ) = ℓ ( x ) ∧ ℓ ( x ) = 1 ] ] = \frac{1}{n} {\sum }_{x ∈ {D}_{t}} {E}_{x ∼ {D}_{t}} [ [ f ( x ) = ℓ ( x ) ∧ ℓ ( x ) = 1 ] ] = \frac{1}{n} {\sum }_{x ∈ {D}_{t}} {tp}^{*} = {tp}^{*}$$

The evaluation statistics [symbol] that correspond to importance sampling estimates under the source data distribution, are unbiased estimators of their underlying indicator functions under the true target distribution Dₜ. It may be shown for true positives but the others are similar.

Moreover, the evaluation metrics y are then functions of these unbiased statistical estimators and are thus themselves consistent estimators in the following sense. Let μ(⋅,⋅,⋅)→s be a real-valued continuous function of the four underlying evaluation statistics. Let tp*, fp*, fn*, tn* be the expected values of each of the four underlying indicator functions under the target distribution Dₜ; for example, tp*=E_{x˜D}_{ₜ}[f(x) [symbol] (x)∧l(x)=1]. Let μ*=μ(tp*, fp*, fn*, tn*) may be the evaluation metric computed directly on the target distribution. Then it may be that μ̅ₙ is consistent. In particular fn [symbol] μ*. As a proof, by strong law of large numbers it may be shown that <t̅p̅ₙ, f̅p̅ₙ, f̅n̅ₙ, t̅n̅ₙ> [symbol] *<tp*, fp*, fn*, tn*>. Since μ is a continuous fraction it may be shown by the continuous mapping theorem that

$${\overline{μ}}_{n} = μ ( {\overline{tp}}_{n} , {\overline{fp}}_{n} , {\overline{fn}}_{n} , {\overline{tn}}_{n} ) {\to }^{a . s .} ( {tp}^{*} , {fp}^{*} , {fn}^{*} , {tn}^{*} ) = {μ}^{*} \qquad ( 1 )$$

Now consider a scenario where there is a target dataset Dₜ for which there are no ground truth labels. Since there are no ground truth labels, the evaluation statistics cannot be directly μ̅ₙ directly on that dataset. However, since evaluation statistics may be expected values of indicator functions, a surrogate labeled dataset can be used that comes from a different distribution, to estimate their expected values. Importance sampling can then be used to rewrite the expectation on the target data distribution as an expectation over the data distribution for the labeled source dataset.

$$\begin{matrix}{E}_{x ∼ {D}_{t}} [ f ( x ) & = & ℓ ( x ) ∧ ℓ ( x ) = 1 ] \approx \frac{1}{n} {\sum }_{x ∈ {D}_{t}} [ f ( x ) = ℓ ( x ) ∧ ℓ ( x ) = 1 ] & ( 2 ) \\ & \approx & \frac{1}{n} {\sum }_{x ∈ {D}_{t}} \frac{{D}_{t} ( x )}{{D}_{s} ( x )} [ f ( x ) = ℓ ( x ) ∧ ℓ ( x ) = 1 ] & ( 3 ) \\ & & & \end{matrix}$$

Note that in Equation 2, the usual way of doing evaluation, uses labels for Dₜ while Equation 3 only uses having labels for Dₛ. However, both are unbiased estimates for E_{x˜D}_{ₜ}. Thus, Dₛ can be used as a surrogate labeled dataset for Dₜ even if it comes from a different data distribution. The importance weights, which may be the ratios of the target and source probabilities, may give more weight to statistics computed on source data that is more likely to appear in the target data, and lower weight to source data that is unlikely to appear in the target data. Continuing with our running example, performance metric precision can be determined on the target data but using only labels from the source data:

$$= \frac{1}{n} {\sum }_{x ∈ {D}_{s}} \frac{{D}_{t} ( x )}{{D}_{s} ( x )} [ f ( x ) = ℓ ( x ) ∧ ℓ ( x ) = 1 ] \qquad ( 4 )$$

$$= \frac{1}{n} {\sum }_{x ∈ {D}_{s}} \frac{{D}_{t} ( x )}{{D}_{s} ( x )} [ f ( x ) \neq ℓ ( x ) ∧ f ( x ) = 1 ] \qquad ( 5 )$$

$${\hat{μ}}_{n} = \frac{\hat{{tp}_{n}}}{\hat{{tp}_{n}} + \hat{{fp}_{n}}} \qquad ( 6 )$$

and can similarly be used to determine compute other metrics like recall, F1, and accuracy. Note that these estimators are consistent too, in the sense that they also converge in the limit of infinite data to the evaluation metric when computed on the target data distribution.

In some embodiments, [symbol] is an unbiased estimator. In particular, E_{x˜D}_{ₛ} [ [symbol] ]=|tp*. As a proof:

$$\begin{matrix}{E}_{x ∼ {D}_{s}} [ ] & = & {E}_{x ∼ {D}_{s}} [ \frac{1}{n} {\sum }_{x ∈ D} \frac{{D}_{t} ( x )}{{D}_{s} ( x )} [ f ( x ) = ℓ ( x ) ∧ ℓ ( x ) = 1 ] & ( 7 ) \\ & = & \frac{1}{n} {\sum }_{x ∈ {D}_{s}} {E}_{x ∼ {D}_{s}} [ \frac{{D}_{t} ( x )}{{D}_{s} ( x )} g ( f ( x ) , ℓ ( x ) ) ] & ( 8 ) \\ & = & \frac{1}{n} {\sum }_{x ∈ {D}_{s}} {\int }_{{D}_{s}} {D}_{s} ( x ) \frac{{D}_{t} ( x )}{{D}_{s} ( x )} g ( f ( x ) , ℓ ( x ) ) dx & ( 9 ) \\ & = & \frac{1}{n} {\sum }_{x ∈ {D}_{s}} {\int }_{{D}_{s}} {D}_{t} ( x ) g ( f ( x ) , ℓ ( x ) ) dx & ( 10 ) \\ & = & \frac{1}{n} {\sum }_{x ∈ {D}_{s}} {E}_{x ∼ {D}_{t}} [ g ( f ( x ) , ℓ ( x ) ) ] & ( 11 ) \\ & = & \frac{1}{n} {\sum }_{x ∈ {D}_{t}} {tp}^{*} & ( 12 ) \\ & = & {tp}^{*} & ( 13 )\end{matrix}$$

Again, note that \hat{μ} is consistent. In particular \hat{μ}ₙ [symbol] μ*. As a proof, by strong law of large numbers it may be shown that [symbol] [symbol] [symbol] <tp*,fp*,fn*,tn*>. Since μ is a continuous fraction it may be shown by the continuous mapping theorem that

$${\hat{μ}}_{n} = μ ( ) {\to }^{a . s .} ( {tp}^{*} , {fp}^{*} , {fn}^{*} , {tn}^{*} ) = {μ}^{*}$$

Thus, in the limit of infinite data, the importance sampling estimate \hat{μ}ₙ for an evaluation metric that is computed on the source data, converges to the same value μ* as the Monte Carlo estimate μ̅ₙ of the evaluation metric when computed on the labeled target data.

In various embodiments, density estimation may be used as proxies for data distributions. In various scenarios, there is no access to the underlying data distributions of deployment data (perhaps except in cases in which synthetic or simulated data is involved).

To this end, density estimates may be utilized, in various embodiments, that are computed directly from the datasets themselves, to approximate them. If an assumption is made that the labeling function is the same for both datasets, then [symbol] (x) can be ignored and just compute the densities directly from x. In particular, a target density estimator Prₜ can be trained to approximate D directly from the observed x∈Dₛ. Similarly, the same can be done for the source data and train a density estimator Prₛ directly from the x∈Dₛ. These density estimates can then be used instead of the true estimators as shown in the examples above.

In various embodiments, the techniques for determining machine learning model performance on unlabeled out of distribution data may have wide applicability. For example, in some embodiments, the techniques for determining machine learning model performance on unlabeled out of distribution data may be used as a method for evaluating document classifiers and named entity recognition systems in the wild. For this, appropriate density estimates of the test data and the deployment data may be determined. While labeled datasets such as the test dataset (e.g., from the source dataset) are typically small, density estimators may not require labeled data and so the size of the dataset can be expanded that is used to fit the density estimate as long as the samples come from the same distribution (e.g., the training set or some other unlabeled portion of the data). In one example embodiment, an n-gram based language model may be used. In such an embodiment, fit an n-gram model to the test dataset to obtain Pr(x) and fit another to the target dataset (e.g., deployment set) to obtain Pr′(x).

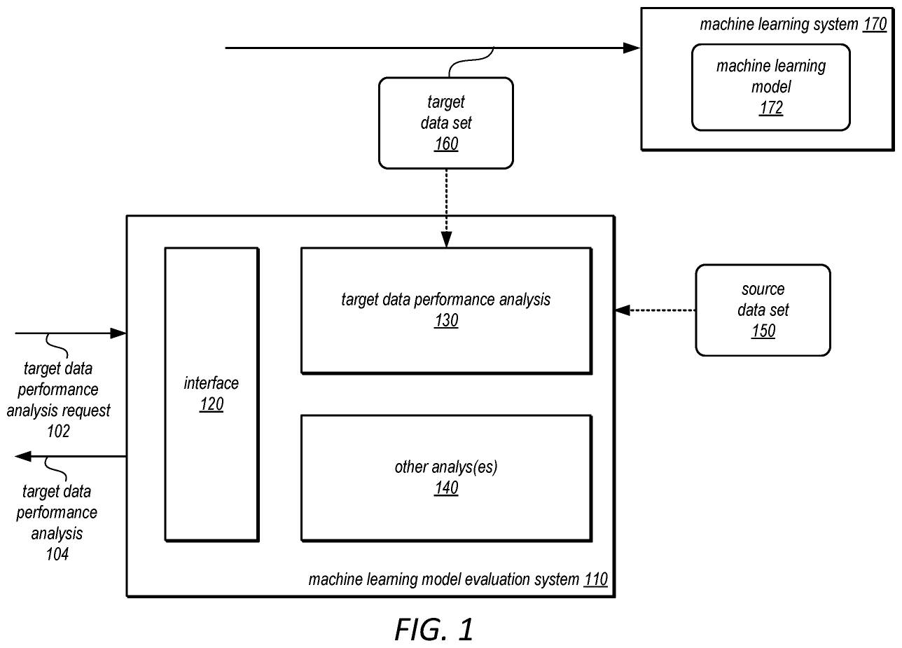

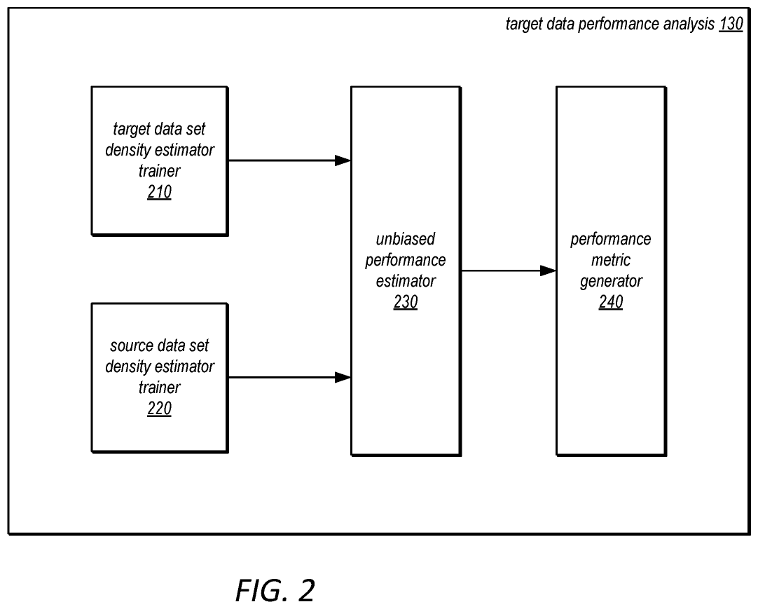

FIG. 1 is a logical block diagram of an exemplary machine learning evaluation system that implements target data performance analysis for a machine learning model system, according to some embodiments. Machine learning model evaluation system 110 may implement the various techniques discussed above (and below with regard to FIGS. 2-4. Machine learning model evaluation system 110 may be implemented as part of a stand-alone application, system, or service (including a cloud service). In some embodiments, machine learning model evaluation system 110 may be implemented as a feature of a machine learning model training or development application, system, or service (including a cloud service).

Machine learning model evaluation system 110 may accept target data performance analysis requests 102, in some embodiments. Target datasets, such as target dataset 160, may be the input data to a deployed machine learning model, such as machine learning model 172 in machine learning model system 170. To determine machine learning model 172's performance, machine learning model evaluation system 110 may implement target data performance analysis 130, as discussed below with regard to FIG. 2, which may utilize both target dataset 160 and source dataset 150.

Interface 120 may support the target data performance analysis request 102 and response with performance analysis 104 with performance metrics as determined for the machine learning model 172 on target dataset 160. Interface 120 may support various types of interaction, such as a graphical user interface, command line interface, and/or a programmatic interface (e.g., Application Programming Interfaces (APIs)). Request 104 can specify which performance metrics (out of the set of supported performance metrics) to determine as well as provide other information for performing the performance metric analysis, such as identifiers and/or location of the target dataset 160, source dataset 150, and machine learning model 172. Performance analysis 104 may include performance metrics formatted in various ways (e.g., metrics values, graphs, or other visualizations).

In some embodiments, target data performance analysis 130 may be implemented with other features or analyses 140. For example, test data may be evaluated that is taken from source data and includes ground truth labels (e.g., to provide a comparison with target dataset analysis.

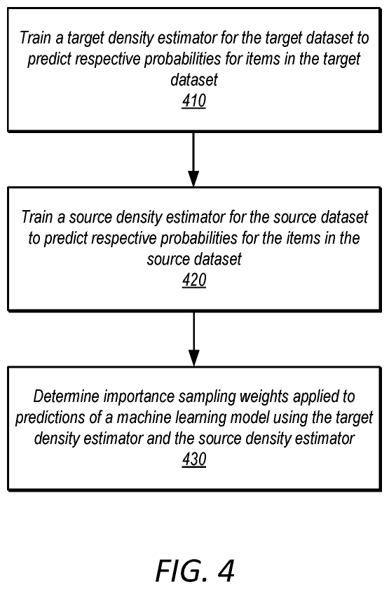

FIG. 2 is a logical block diagram illustrating target data performance analysis for a machine learning model, according to some embodiments. In some embodiments, the distribution of target data can be known so that importance weights can be determined. In other embodiments, density estimation techniques can be applied. For example, as indicated at 210, target data performance analysis 130 may implement target dataset density estimator trainer 210. Target dataset density estimator trainer 210 can apply various machine learning or other techniques to determine a density estimator, such as probability density function, to provide densities of given items in the target dataset, as discussed in detail below with regard to FIG. 4.

In some embodiments, target data performance analysis 130 may implement source dataset density estimator trainer 220. Target dataset density estimator trainer 210 can apply various machine learning or other techniques to determine a density estimator, such as probability density function, to provide densities of given items in the target dataset, as discussed in detail below with regard to FIG. 4.

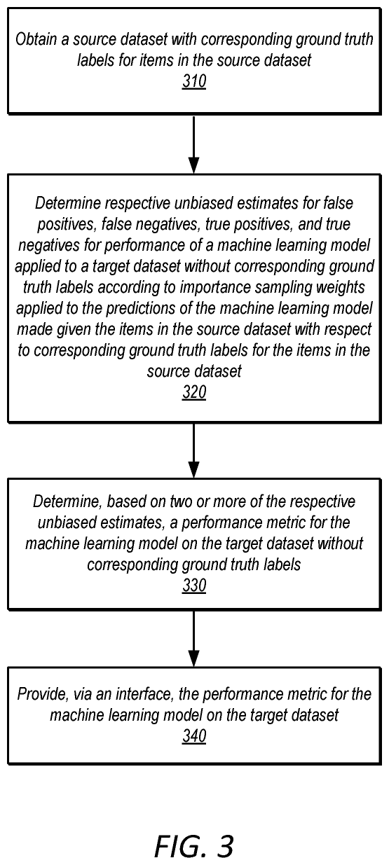

In some embodiments, target data performance analysis 130 may implement unbiased performance estimator 230. Unbiased performance estimator 230 may implement the techniques discussed above and below with regard to FIG. 3 to determine the estimated baseline performance indicators used to determine performance metrics for a target dataset. For example, given the trained density estimators importance sampling weights may be determined. Then, unbiased estimates for the baseline performance indicators, false positives, false negatives, true positives, and true negatives, may be determined for the target dataset.

In some embodiments, target data performance analysis 130 may implement performance metric generator 240. Performance metric generator 240 may utilize different combinations of baseline performance indicators estimated at 230 to generate one or more performance metrics. As discussed in detail below with regard to FIG. 3, the metrics may include both linear and non-linear metrics as well as fairness metrics.

The example systems described above may implement determining machine learning model performance on target datasets that are not labeled. However, various other systems, services, or applications may implement similar techniques. Therefore, FIG. 3 is a flow diagram illustrating methods and techniques for determining machine learning model performance on un-labeled performance distribution data, according to some embodiments, which may be implemented by a variety of systems, services, or applications, in addition to those discussed above with regard to FIGS. 1 and 2.

As indicated at 310, a source dataset with corresponding ground truth labels for items in the source dataset may be obtained, in some embodiments. For example, the source data set may be specified as part of a request to provide performance metrics and retrieved from an identified data store. In some embodiments, the source dataset may be provided as part of a model training and development pipeline or other execution process that includes both training and testing for a machine learning model, which may include evaluation of performance on a target dataset according to the techniques discussed below.

As indicated at 320, respective unbiased estimates may be determined for false positives, false negatives, true positives, and true negatives for performance of a machine learning model applied to a target dataset without corresponding ground truth labels according to importance sampling weights applied to the predictions of the machine learning model made given the items in the source dataset with respect to corresponding ground truth labels for the items in the source dataset, according to some embodiments. For example, as discussed in detail above importance sampling weights may be determined according to a known (or likely) distribution of items in a ratio of target to source datasets. In another embodiments, as discussed above and below with regard to FIG. 4, density estimators may be trained and used to determine importance sampling weights. Given the importance sampling weights, unbiased estimates for the baseline performance indicators, false positives, false negatives, true positives, and true negatives, may be determined for the target dataset.

As indicated at 330, based on two or more of the respective unbiased estimates, a performance metric may be determined for the machine learning model on the target dataset without corresponding ground truth labels, according to some embodiments. As discussed above, different performance metrics may be supported and specified. Some performance metrics may be linear, some may be non-linear, and some may be indicative of other characteristics of the machine learning model's performance, such as bias.

One performance metric may be precision. Precision may be determined using the unbiased estimates for true-positives and false-positives. The number of true positives may be divided by the sum of true positives and false positives (e.g., Precision=true positives/(true positives+false positives).

Another performance metric may be recall. Recall may be determined using the unbiased estimates for true-positives and false-negatives. The number of true positives may be divided by the sum of true positives and false negatives (e.g., Precision=true positives/(true positives+false negatives).

Another performance metric may be F1. F1 may be determined using the precision and recall performance metrics. F1 may be (2*Precision*Recall)/(Precision+Recall).

Another performance metric that may be determined is accuracy. Accuracy may be the total number of correct predictions divided by the total number of predictions made for a dataset. Thus accuracy may be (true positives+true negatives)/(true positives+true negatives+false positives+false negatives).

As indicated at 340, the performance metric for the machine learning model on the target dataset may be provided via an interface of the machine learning model evaluation system. As discussed above, performance metrics can be provided through various types of interfaces and displayed or indicated in various ways.

As discussed above, in some scenarios the distribution of data in a target dataset may be unknown. Live data, real world data, or other data received for a machine learning model to generate an inference may be received as the target dataset, for instance. To determine performance metrics for the target dataset in such scenarios, density estimation techniques may be used, in some embodiments. FIG. 4 is a flow diagram illustrating methods and techniques for training density estimators for determining machine learning model performance, according to some embodiments.

As indicated at 410, a target density estimator may be trained for the target dataset to predict respective probabilities for items in the target dataset, according to some embodiments. For example, techniques such as kernel density estimation or other techniques (e.g., an n-gram model fit as discussed above) that repeatedly sample items from the target dataset to fit a probability density function to provide a probability density estimation for target dataset values.

As indicated at 420, a source density estimator may be trained for the source dataset to predict respective probabilities for items in the source dataset, according to some embodiments. Similar to the discussion above at 410, techniques such as kernel density estimation or other techniques (e.g., an n-gram model fit as discussed above) that repeatedly sample items from the source dataset to fit a probability density function to provide a probability density estimation for source dataset values.

As indicated at 430, importance sampling weights applied to predictions of a machine learning model may be determined using the target density estimator and the source density estimator, in some embodiments. For example, the ratio of target density to source density (target density/source density), may be used to determine the importance sampling weight for a given value or item in a target data set. As mentioned above using trained density estimators may avoid the use of labels for a target dataset and therefore may allow for larger datasets to be used to train the density estimators.

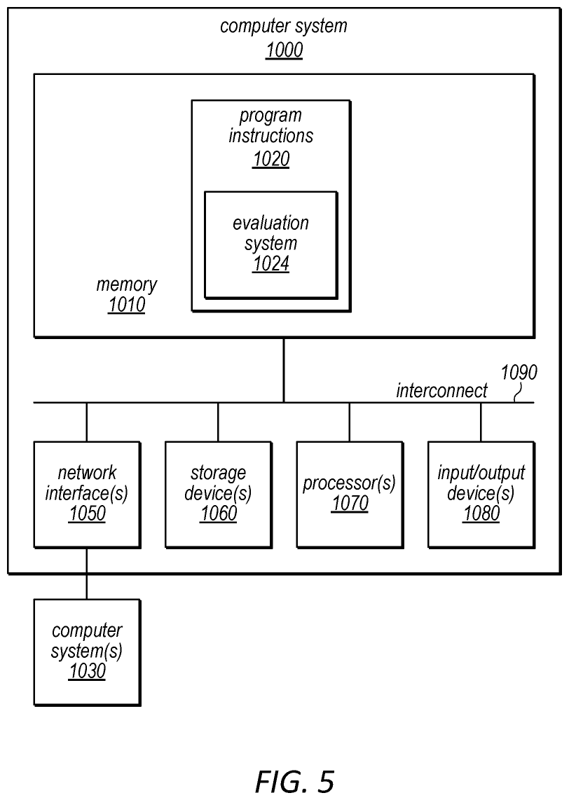

FIG. 5 illustrates a computing system configured to implement the methods and techniques described herein, according to various embodiments. The computer system 1000 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any type of computing device.

The mechanisms for implementing online post-processing in rankings for constrained utility maximization, as described herein, may be provided as a computer program product, or software, that may include a non-transitory, computer-readable storage medium having stored thereon instructions, which may be used to program a computer system (or other electronic devices) to perform a process according to various embodiments. A non-transitory, computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

In various embodiments, computer system 1000 may include one or more processors 1070; each may include multiple cores, any of which may be single or multi-threaded. Each of the processors 1070 may include a hierarchy of caches, in various embodiments. The computer system 1000 may also include one or more persistent storage devices 1060 (e.g. optical storage, magnetic storage, hard drive, tape drive, solid state memory, etc.) and one or more system memories 1010 (e.g., one or more of cache, SRAM, DRAM, RDRAM, EDO RAM, DDR 10 RAM, SDRAM, Rambus RAM, EEPROM, etc.).

Various embodiments may include fewer or additional components not illustrated in FIG. 5 (e.g., video cards, audio cards, additional network interfaces, peripheral devices, a network interface such as an ATM interface, an Ethernet interface, a Frame Relay interface, etc.)

The one or more processors 1070, the storage device(s) 1050, and the system memory 1010 may be coupled to the system interconnect 1040. One or more of the system memories 1010 may contain program instructions 1020. Program instructions 1020 may be executable to implement various features described above, including a machine learning model evaluation system 1024 as discussed above with regard to FIG. 1 that may perform the various evaluation of machine learning models, in some embodiments as described herein. Although not illustrated, similar techniques can be employed for the machine learning system also illustrated in FIG. 1. Program instructions 1020 may be encoded in platform native binary, any interpreted language such as Java™ byte-code, or in any other language such as C/C++, Java™, etc. or in any combination thereof. System memories 1010 may also contain LRU queue(s) 1026 upon which concurrent remove and add-to-front operations may be performed, in some embodiments.

In one embodiment, Interconnect 1090 may be configured to coordinate I/O traffic between processors 1070, storage devices 1070, and any peripheral devices in the device, including network interfaces 1050 or other peripheral interfaces, such as input/output devices 1080. In some embodiments, Interconnect 1090 may perform any necessary protocol, timing or other data transformations to convert data signals from one component (e.g., system memory 1010) into a format suitable for use by another component (e.g., processor 1070). In some embodiments, Interconnect 1090 may include support for devices attached through various types of peripheral buses, such as a variant of the Peripheral Component Interconnect (PCI) bus standard or the Universal Serial Bus (USB) standard, for example. In some embodiments, the function of Interconnect 1090 may be split into two or more separate components, such as a north bridge and a south bridge, for example. In addition, in some embodiments some or all of the functionality of Interconnect 1090, such as an interface to system memory 1010, may be incorporated directly into processor 1070.

Network interface 1050 may be configured to allow data to be exchanged between computer system 1000 and other devices attached to a network, such as other computer systems, or between nodes of computer system 1000. In various embodiments, network interface 1050 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1080 may, in some embodiments, include one or more display terminals, keyboards, keypads, touchpads, scanning devices, voice or optical recognition devices, or any other devices suitable for entering or retrieving data by one or more computer system 1000. Multiple input/output devices 1080 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1050.

Those skilled in the art will appreciate that computer system 1000 is merely illustrative and is not intended to limit the scope of the methods for providing enhanced accountability and trust in distributed ledgers as described herein. In particular, the computer system and devices may include any combination of hardware or software that may perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed:

1. A system, comprising:
at least one processor;
a memory, comprising program instructions that when executed by the at least one processor cause the at least one processor to implement a machine learning model evaluation system, the machine learning model evaluation system configured to:
receive, via an interface for the machine learning model evaluation system, a request for a performance metric;
obtain a source dataset with corresponding ground truth labels for items in the source dataset;
determine respective unbiased estimates for false positives, false negatives, true positives, and true negatives for performance of a machine learning model applied to a target dataset without corresponding ground truth labels according to importance sampling weights applied to the predictions of the machine learning model made given the items in the source dataset with respect to corresponding ground truth labels for the items in the source dataset;
determine, based on two or more of the respective unbiased estimates, a performance metric for the machine learning model on the target dataset without corresponding ground truth labels; and
return, via the interface, the performance metric for the machine learning model on the target dataset.

2. The system of claim 1, wherein the machine learning model evaluation system is further configured to:
train a target density estimator for the target dataset to predict respective probabilities for items in the target dataset;
train a source density estimator for the source dataset to predict respective probabilities for the items in the source dataset; and
determine the importance sampling weights applied to the predictions of the machine learning model using the target density estimator and the source density estimator.

3. The system of claim 1, wherein the target dataset is a simulated dataset.

4. The system of claim 1, wherein the performance metric for the machine learning model on the target dataset is a non-linear performance metric.

5. The system of claim 1, wherein the machine learning model is a document classifier.

6. The system of claim 1, wherein the performance metric for the machine learning model on the target dataset is a fairness metric.

7. A method, comprising:
performing, by one or more computing devices:
obtaining a source dataset with corresponding ground truth labels for items in the source dataset;
determining respective unbiased estimates for false positives, false negatives, true positives, and true negatives for performance of a machine learning model applied to a target dataset without corresponding ground truth labels according to importance sampling weights applied to the predictions of the machine learning model made given the items in the source dataset with respect to corresponding ground truth labels for the items in the source dataset;
determining, based on two or more of the respective unbiased estimates, a performance metric for the machine learning model on the target dataset without corresponding ground truth labels; and
providing, via an interface, the performance metric for the machine learning model on the target dataset.

8. The method of claim 7, further comprising:
training a target density estimator for the target dataset to predict respective probabilities for items in the target dataset;
training a source density estimator for the source dataset to predict respective probabilities for the items in the source dataset; and
determining the importance sampling weights applied to the predictions of the machine learning model using the target density estimator and the source density estimator.

9. The method of claim 7, wherein the performance metric for the machine learning model on the target dataset is a non-linear performance metric.

10. The method of claim 7, wherein the performance metric for the machine learning model on the target dataset is a fairness metric.

11. The method of claim 7, wherein the target dataset is a synthetic dataset.

12. The method of claim 7, wherein the machine learning model performs named entity recognition.

13. The method of claim 7, further comprising receiving, via the interface, a request to provide the performance metric for the machine learning model on the target dataset.

14. One or more non-transitory, computer-readable storage media, storing program instructions that when executed on or across one or more computing devices, cause the one or more computing devices to implement:
obtaining a source dataset with corresponding ground truth labels for items in the source dataset;
determining respective unbiased estimates for false positives, false negatives, true positives, and true negatives for performance of a machine learning model applied to a target dataset without corresponding ground truth labels according to importance sampling weights applied to the predictions of the machine learning model made given the items in the source dataset with respect to corresponding ground truth labels for the items in the source dataset;
determining, based on two or more of the respective unbiased estimates, a performance metric for the machine learning model on the target dataset without corresponding ground truth labels; and
providing, via an interface, the performance metric for the machine learning model on the target dataset.

15. The one or more non-transitory, computer-readable storage media of claim 14, storing further program instructions that when executed on or across the one or more computing devices cause the one or more computing devices to further implement:
training a target density estimator for the target dataset to predict respective probabilities for items in the target dataset;
training a source density estimator for the source dataset to predict respective probabilities for the items in the source dataset; and
determining the importance sampling weights applied to the predictions of the machine learning model using the target density estimator and the source density estimator.

16. The one or more non-transitory, computer-readable storage media of claim 14, wherein the performance metric for the machine learning model on the target dataset is a linear performance metric.

17. The one or more non-transitory, computer-readable storage media of claim 14, wherein the performance metric for the machine learning model on the target dataset is a non-linear performance metric.

18. The one or more non-transitory, computer-readable storage media of claim 14, wherein the target dataset is a synthetic dataset.

19. The one or more non-transitory, computer-readable storage media of claim 14, wherein the machine learning model is a document classifier.

20. The one or more non-transitory, computer-readable storage media of claim 14, storing further program instructions that when executed on or across the one or more computing devices cause the one or more computing devices to further implement receiving, via the interface, a request to provide the performance metric for the machine learning model on the target dataset.
